(19) United States
(12) Patent Application Publication
(10) Pub. No.: US 2006/0080145 A1
(43) Pub. Date: Apr. 13, 2006

(54) Method for reviewing electronic patient medical records to assess and improve the quality and cost effectiveness of medical care

(76) Inventors: Roger Harvey Cook, Los Alamos, NM (US); Olha Pavlivna Molchanova, Los Alamos, NM (US)

Correspondence Address: Roger Cook, 119 Grand Canyon Drive, Los Alamos, NM, 87544, US

(21) Appl. No.: 11/231,672

(22) Filed: Sep. 21, 2005

Related U.S. Application Data
(60) Provisional application No. 60/613,272, filed on Sep. 27, 2004.

(51) Int. Cl. G06Q 10/00

(52) U.S. Cl. 705/2

(57) ABSTRACT

Process and system for the review of electronic medical records to detect potential problems with healthcare including inappropriate medication use, missed opportunities for beneficial medication use and missed opportunities for appropriate healthcare screening. The review is done by a computer program which applies up to date evidence based medical information. The client can be the patient or a third party and results of the review are returned to the client for the purposes of assessing the quality of medical care and optimizing medical care.

### CROSS-REFERENCE TO RELATED APPLICATIONS

This application claims the benefit of provisional patent application Ser. No. 60/613,272, filed Sep. 27, 2004 by the present inventors.

### FEDERALLY SPONSORED RESEARCH

Not applicable

### SEQUENCE LISTING OR PROGRAM

Not applicable

### BACKGROUND OF THE INVENTION

1. Field of Invention

Electronic medical record systems and medical quality review.

2. Background

Many electronic medical record (EMR) systems already exist but they are not yet in widespread use. In April 2004 President Bush pushed forward the effort to computerize health care when he stated “Within 10 years, every American must have a personal electronic medical record”. The next day he signed an executive order to achieve this goal. It is expected that current compatibility issues among EMR systems will be resolved in the near future probably through recently established data standards as described at the Department of Health & Human Services website:

http://www.hhs.gov/news/press/2004pres/20040506.html and the use of a common XML output format for exporting data.

Thus the widespread use of compatible EMR systems is imminent. With this will come the ability to easily transfer entire medical records electronically.

While some EMR systems still store data as free text most systems store data in formats that can be interpreted by computers. It is expected that there will be further advances in this direction in the future. This opens the opportunity for the EMR data to be examined by a computer program for the purposes of assessment and improvement of quality of medical care in ways and on a scale that is impractical with paper medical records.

As more and more healthcare providers convert to EMR systems there will be enormous opportunities for computerized healthcare quality assessment and improvement and, in particular, opportunities for consumer involvement.

### THE NEED FOR THIS INVENTION

Many studies have been done to determine the best way to care for common medical conditions. These have shown certain treatments to be clearly superior to others in reducing morbidity and mortality.

Other investigators have examined how well these lessons are being applied in day to day medicine. The results were disappointing. For example:

“Findings from various studies indicate considerable under use of beta blockers following myocardial infarction, with only 20 to 50 percent of eligible patients receiving these agents. “. . . “a twofold variation in beta-blocker use was observed in different regions of the country”. American Family Physician Oct. 15, 2000.

“Data suggest that as many as 25% of “ideal candidates” do not receive therapies that are proven to reduce morbidity and mortality, such as angiotensin-converting enzyme (ACE) inhibitors. Underutilization of effective therapies, combined with under dosing, may in part account for the poor prognosis in patients with CHF [congestive heart failure].” POSTGRADUATE MEDICINE VOL 105/NO 6/MAY 15, 1999.

“the Rand Corporation found that Americans get recommended care only 55 percent of the time” US Department of Health & Human Services HHS Fact Sheet, Jul. 21, 2004.

In addition to the problem of under use of appropriate medications there are other studies which show that inappropriate medications are prescribed quite frequently.

In a study of skilled nursing facilities the following was found: “Based on the consensus criteria, 40% of residents received at least one inappropriate medication order, and 10% received two or more inappropriate medication orders concurrently; 7% of all prescriptions were inappropriate.” Ann Intern Med. 1992 Oct. 15; 117(8):684-9.

The prescription of combinations of drugs with potentially harmful interactions is very common:

“Half of the patients were given drug-combinations with the potential for drug-drug interactions, whereby 5% were at risk for the development of interactions of severe and 42% of intermediate degree.” Schweiz Rundsch Med Prax. 2000 Jan. 27;89(5):182-9.

“At the outset, nearly 75 percent of patients had at least one potential drug-drug interaction of “any significance” and 35 percent had “highly significant” drug interactions.” American Journal of Hypertension May 2004.

Unfortunately even fatal medical errors are not uncommon.

“The Institute of Medicine has estimated that 45,000 to 98,000 deaths occur each year due to medical errors.” US Department of Health & Human Services HHS Fact Sheet, Jul. 21, 2004. An 8-9-2004 report by HealthGrades increased the estimated number of deaths to 195,000 per year.

At present most patients are not aware that the probability of dangerous errors and omissions in their health care is so high. Even if they were aware of these facts they would have no easy way to determine if they are personally affected much less the specifics of the errors or omissions. Patients naturally want to receive the proper standard of medical care. From the moment this invention was conceived the first goal was to provide a practical way for patients to assess and to improve the quality of the healthcare that they are receiving.

### THE PRIOR ART

To assess the quality of the medical care that he is receiving the patient can do his own studying to learn about his medical conditions, medications and appropriate screening interventions. He can then discuss the information that he has learned with his healthcare provider. This is an ideal solution but in practice it has very limited use because significant medical training is necessary to find and comprehend the large volume of information necessary and then apply it to the individual case. Patients who are highly educated in non-medical fields often get confused trying to do this.

Healthcare providers sometimes do manual reviews of medical records to assess the quality of the medical care they are delivering. This can be very effective but it is so time consuming that in practice it is done infrequently, on small numbers of patient records and looking at very limited data. It does not provide any information to the patient and cannot be considered an unbiased source of data for a third party.

In a sense this invention provides a “second opinion” for the patient. The usual prior art relating to second opinions is that a patient obtains a second opinion in person from another physician. This is time consuming and expensive because of duplication of care. It has a clear advantage in that the medical second opinion can detect incorrect diagnoses and treatments which a computerized review system could miss. In practice the system of seeing another physician for a second opinion is impractical except when there are serious medical problems with doubt about the diagnosis or treatment or for decisions regarding things such as the need for surgery. The large scale application of this system of medical record review is not cost effective.

Second opinions are offered on-line by a number of organizations. In each case the second opinion consists of a health care provider manually reviewing a paper or electronic copy of the patient's chart:

i. http://.www.physicians-background.com/

ii. http://www.espine.com/purchase.html

iii. http://www.thyroid.com/2ndopinion.html

iv. http://www.worldcare.com/NewFiles/second_opinion.html

This is similar to the last example except that the health care provider does not see the patient in person. It has the same disadvantages as the last example and the additional problem that failure to see the patient in person deprives the healthcare provider of valuable information.

The analysis of complicated medical problems requires a human professional. It is time consuming and therefore expensive but computers are not yet capable of doing such work. This invention is not intended for the analysis of complicated medical problems and is not intended to compete with review by a skilled human.

A medical record can be analyzed, looking for problems such as inappropriate medication use, missed opportunities for beneficial medication use and missed opportunities for appropriate health care screening. This type of analysis is relatively simple except that it requires the very repetitive application of a large number of algorithms. A human would quickly get bored and make mistakes doing such work but a computer can do this job tirelessly, flawlessly and inexpensively.

Computerized medical record review is not entirely new. Some organizations such as health insurance companies use billing data to produce data on physician performance. Two examples are US Patent # 20020173992, “Episode treatment groups of correlated medical claims” and U.S. Pat. No. 5,544,044, “Method for evaluation of health care quality”. Computerized review of billing data could be used to help patients and third parties assess the quality of health care provided by an individual healthcare provider. Billing information is often not very accurate and it also represents only a tiny fraction of the information in an EMR. Therefore such a system can never provide reliable, sophisticated reports to patients or to third parties.

U.S. Pat. No. 6,230,142, “Health care data manipulation and analysis system” provides healthcare data analysis for the purpose of decision support in relation to clinical pathways as well as automated development of new clinical pathways and the assessment of established clinical pathways. For example it provides assistance in the decision of when to discharge a patient from hospital: “computerized system is used to address the issue of sending patients home at an appropriate time in the post-operative period.” It does not provide reporting to patients to assist them in optimizing their healthcare.

Some organizations such as pharmacies report possible drug interactions and inappropriate prescriptions to the healthcare provider. For example U.S. Pat. No. 5,845,255 “Prescription management system”. In such cases the source of the information is prescriptions and therefore represents only a very small fraction of the data in the medical record. As with the analysis of billing data the information being analyzed is so small that there is limited potential to improve healthcare. Even when this system is used the patient and third parties usually do not receive the result of the review.

Some EMR systems include “just in time” decision making support. At present decision support exists mainly in the form of notifying the healthcare provider of a drug interaction or of the need to attend to a health maintenance issue. Because a computerized reminder can be ignored the outcome is dependent on the diligence of the healthcare provider. Also, having a reminder system is valuable but it does not help us to measure outcomes.

Some systems such as Cerner's “Ambulatory Electronic Medical Record” provide reporting “to identify patients late for immunizations or standard visits”. Others such as MedcomSoft provide data mining capability through the creation of queries which can be saved for future use. These systems provide a report to the healthcare provider but do not ensure that the healthcare provider does anything with the data. They do not provide any reporting to patients or third parties.

US Patent Application # 20040143462, “Process and system for enhancing medical patient care” describes a system which extracts disease specific medical data from electronic medical records. This invention provides a different service in that it:

1. Queries a database of patient records.

2. Selects patients with a specific “existing or threatened health related condition”.

3. “reformats that information to enable rapid analysis by a health care provider”.

This system does not provide any information to the patient and it does not eliminate skilled human analysis of the data.

US Patent Application # 20040030584, “System and method for guideline-based, rules assisted medical and disability management” provides a “method for managing medical care” which involves computerized analysis of patient medical data. Electronic medical records are considered as one possible source of the data but it is not an essential part of the invention. This is a system for case management such as might be used by a worker's compensation organization. The claims are specific in stating that this is a method for “managing” but they are vague when they state “generating at least one message” without specifying where the message is to go. There are 10 references to messages in the description and in every case the message is going to the healthcare provider, the supervisor or the care manager. Nowhere in this patent application is there any reference to providing the results of the analysis of the medical record to the patient or to any external party excepting the provider.

Organizations such as Medical specialty boards, insurance companies, professional licensing authorities and hospitals have a critical need to assess the performance of healthcare providers. They often rely on professional references which are always subjective and depend on how carefully the healthcare provider chooses his references.

One of the main reasons for the existence of medical specialty boards is to assess the competence of healthcare providers in that specialty. They do this primarily through examinations which assess knowledge but do not assess day to day practice. The American Board of Family Practice (ABFP) attempts to review actual clinical practice using what they call a “computerized review of patient charts” once every seven years. In this review system the physician chooses two patient charts for each of two diseases. The physician reviews the charts himself, against a set of standards, completes a computer scan form and sends this to the examining board. The form is scanned and the responses are tabulated by a computer program. The amount of data collected from each patient chart is quite small. Even if the physician chooses the charts randomly (unlikely to happen) and reports the results honestly, the result of the examination of four charts once every seven years has little if any statistical significance. Even the ABFP acknowledges that this program is more of a learning process than an assessment process. The recertification process is without any reliable assessment of the performance of the healthcare provider in day to day practice.

At http://www.bcm.edu/pa/speech.htm there is a description of a vision for health care in 2010. It says “establish quality parameters; all health plans would be required to submit such data to local agencies. The EMRs would make these submissions automatically, eliminating any need for retrospective chart review.” “Each individual would have the ability to fashion a personalized report card comparing physicians and plans on the items that matter most to them. The data for building these report cards would be available on the Internet.” This proposal clearly puts the responsibility for data collection into the hands of the health plans which then report to local agencies which in turn make the reports on individual healthcare providers and health plans available to the public. This system claims to allow anyone to see how a specific health plan or healthcare provider is performing. There are many problems with this proposal.
i. It does nothing to help a patient assess the quality of the healthcare that he, as an individual patient, is receiving.
ii. As of February 2004 there were 572 different health plans operating in the US (http://ebm.vanderbilt.edu/publications/04feb5_mng_care_healthcare_informatic s_mag.pdf). This proposal depends on all 572 health plans independently collecting and analyzing data from all the healthcare providers. This is very inefficient.
iii. It also depends on all 572 health plans uniformly implementing the collection and analysis of data. With such a large number of plans this is unlikely to happen in any case but it is especially unlikely because the health plans are highly motivated to find clever ways in which to collect and process the data in such a way as to make their health plan appear to be performing better than others. This does not provide a reliable independent review process.
iv. There is a many-to-many relationship between health plans and healthcare providers. Collecting data on individual healthcare providers is difficult because no one health plan has all the data for each healthcare provider. It would not work for all the health plans to submit quality parameters to the local agencies as described in this proposal. Instead the health plans would have to submit raw data to the local agencies which would then have to compile the data into statistics for each healthcare provider.
v. Because there would be many local agencies each having to do significant data processing the level of inefficiency goes up again.
vi. Some healthcare providers may practice in the domain of more than one “local agency”. This would invalidate the data unless the many local agencies also shared raw data to compile final statistics, further complicating the analysis.
vii. Health information technology promises efficiency to reduce the cost of healthcare. This proposal results in multiple layers of inefficiency which will increase costs while producing data of dubious reliability.
   Objects and Advantages
   Object

To provide individual patients with information that they can use to assess and optimize the quality of their own medical care.

Advantages

1. Comprehensive—Has access to the entire EMR and therefore does not have the limitations of electronic review of billing or prescription records alone.

2. Expandable and updateable—Because the review is done by computer the medical record can be assessed using as many algorithms as can be developed. As new medical standards are developed new algorithms can be incorporated to keep the process up to date.

3. Cost effective—The cost of medical record analysis by a human increases in direct proportion to the number of records analyzed. The main cost of computerized review of EMRs is developing the software and the algorithms. After the initial development the cost of using the system is very low. This makes computerized review of EMRs well suited to application on a massive scale, something that has not been possible until now.

4. Independent—Provides a low cost means for an individual patient to obtain an independent assessment of many aspects of the quality of the medical care that he receives and, if appropriate, suggestions for areas of his medical care that might be improved.

5. Patient involvement—Provides a means for an individual patient to become more educated about and involved in his own medical care. This education can improve patient compliance which is essential to optimizing outcomes.

Unexpected Advantages

1. Provides a means for the assessment of quality of medical care provided by individual healthcare providers for use by third parties such as medical specialty boards, insurance companies, licensing authorities, and hospitals.

2. Applies pressure on healthcare providers to ensure that they are practicing consistent, quality medical care. Because the healthcare provider will not know which patients will ask for the chart review provided by this invention the healthcare provider will have an incentive to optimize the medical care of all patients.

3. The pressure on healthcare providers to provide consistent, high quality medical care will result in an increased demand for EMR systems with the tools necessary to assist healthcare providers in this task, again benefiting all patients.

4. Better preventive and disease care will result in cost savings.

5. The system can calculate the estimated cost of the patient's drug treatment and suggest possible ways to reduce the cost. The patient can take these suggestions to the healthcare provider for discussion. This kind of review and reporting can save the patient money and improve compliance with treatment at the same time.

6. The system can report to the patient the range of prices from various sources for the exact drugs that the patient is taking and thereby provide the patient with the information they need to use the less expensive sources.

7. Provides a way to compare the outcomes that result from the use of different EMR systems and the clinical support tools that they provide. Publication of the independent assessment of the outcomes that result from use of competing EMR systems will be a strong incentive for the makers of the EMRs to produce software that makes real and measurable improvements in healthcare outcomes.

### SUMMARY

Process and system for computerized review of electronic medical records to detect inappropriate medication use, missed opportunities for beneficial medication use and missed opportunities for appropriate healthcare screening. The review is done by a computer program which applies up to date evidence based medical information. Because the entire medical record is available, a far more detailed analysis can be done than has previously been possible. The client requesting the review can be the patient or a third party. Results are returned to the client for the primary purpose of the assessment and optimization of healthcare quality. This invention has the unanticipated advantage of applying pressures on the healthcare system which will result in improved healthcare quality for all patients including those that do not use the service that this invention provides. It provides the opportunity for third parties such as licensing and certifying boards to assess the quality of healthcare provided by individual practitioners in day to day practice. It also enables different EMRs to be objectively compared to one another in terms of their real-world impact on healthcare. This will give the makers of the EMRs a strong incentive to improve their products in ways that improve outcomes.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIGS. 1 through 7 are diagrams of an example system architecture for the computerized review of EMRs according to one illustrative embodiment.

### DETAILED DESCRIPTION

Preferred Embodiment:

1) A relational database containing client data, patient medical records, and client reports.

2) An updateable and expandable set of algorithms for analysis of EMRs.

3) A software program to apply the algorithms to the analysis of the medical records.

4) An internet website.

Operation—Preferred Implementation:

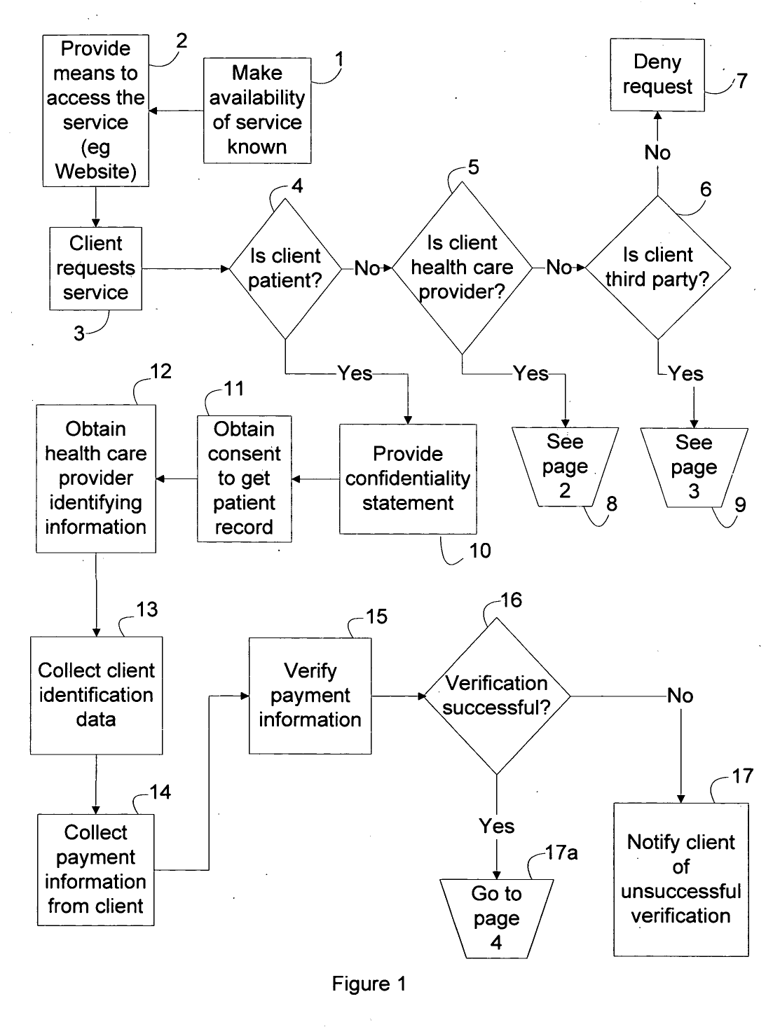

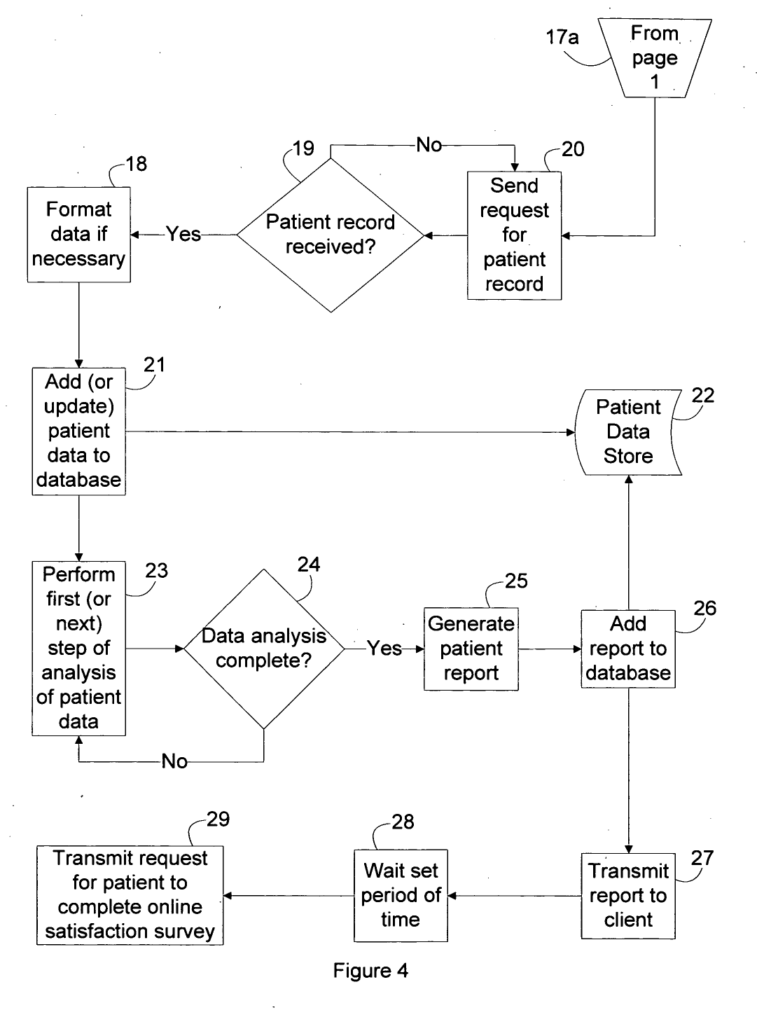

1. Case of patient as client (see FIGS. 1 and 4):
a. The availability of the medical record review service is made known 1 such as through advertising.
b. An Internet website is provided 2 for access to the service.
c. Client requests the computerized review of his or her electronic medical record 3.
d. In this case the client is the patient so test 4 is true.
e. Provide the client with a statement of the confidentiality 10 of the data they release to the service.
f. Obtain 11 consent to get the patient medical record.
g. Obtain 12 identifying information about the healthcare provider from whom the record is to be released.
h. Collect 13 client identifying information so that the correct patient record can be requested.
i. Collect 14 payment information from the client.
j. Verify 15 payment information.
k. Test 16 if verification is successful.
l. If verification unsuccessful then notify 17 client of unsuccessful payment information verification.
m. If verification is successful then (please turn to FIG. 4) send 20 request to healthcare provider for electronic transfer of the patient medical record.
n. After a predetermined period of time check 19 to see if record has been received.
o. If record has not been received then go back to 20.
p. If record has been received then reformat 18 data (if necessary). At first it may only be possible to analyze records transferred from a few EMR systems due to problems of data incompatibility. Some data translation can be done when formats are similar. In time, as industry data formats are standardized this problem will be minimized or eliminated.
q. Add 21 the patient data to the patient data store 22.
r. Perform 23 & 24 the chart analysis. These steps will be described in greater detail below.
s. Generate 25 the patient report and add 26 report to the patient data store 22.
t. Transmit 27 the report to the client.
u. Optionally, wait 28 for a predetermined period of time and then transmit request 29 for the client to complete an online satisfaction survey.

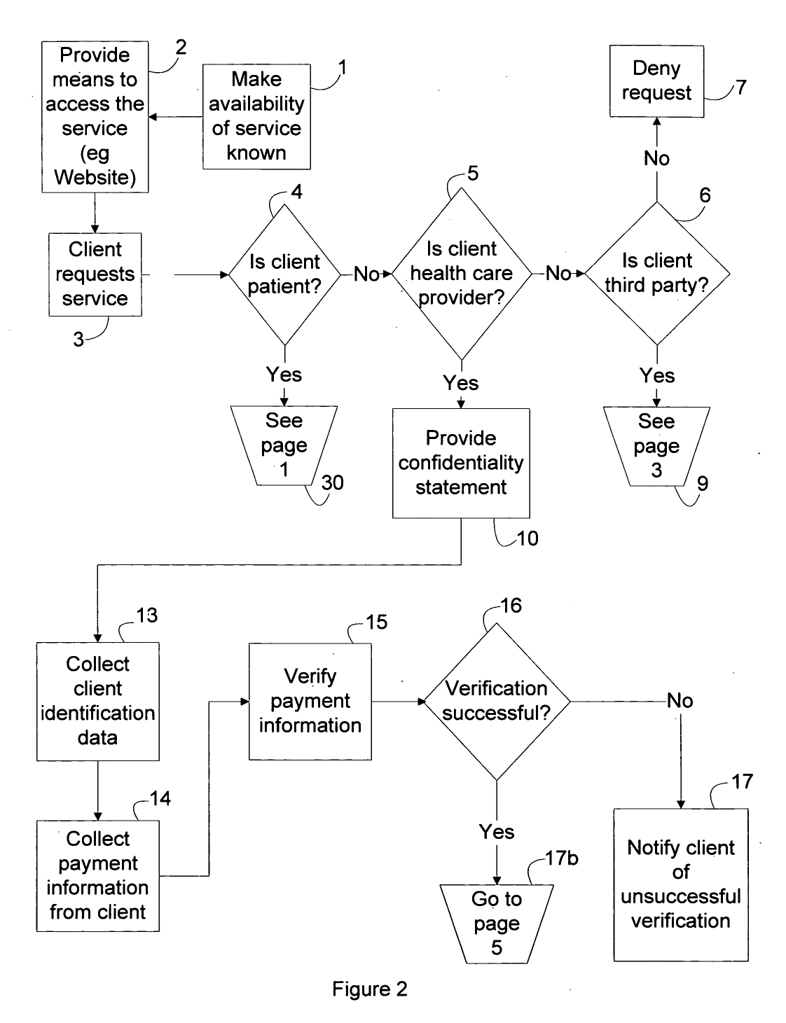

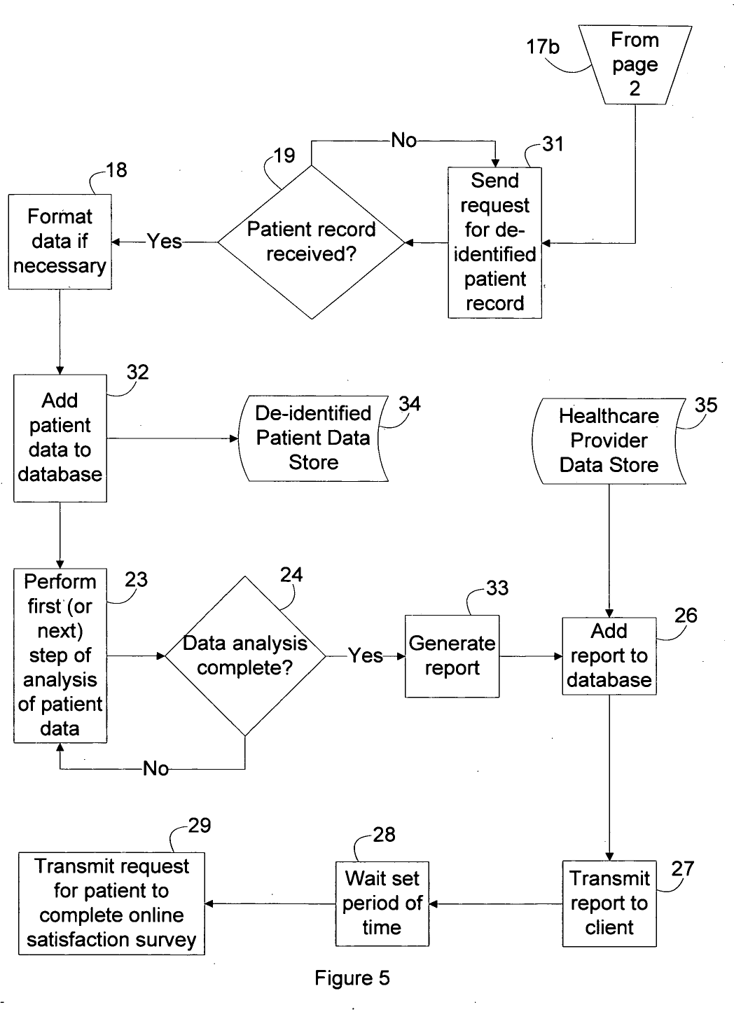

2. Case of healthcare provider as client (see FIG. 2):
a. The availability of the medical record review service is made known 1 such as through advertising.
b. An Internet website is provided 2 for access to the service.
c. Client requests the computerized review of electronic medical records 3.
d. In this case the client is the healthcare provider so test 4 is false.
e. In this case the client is the healthcare provider so test 5 is true.
f. Provide the client with a statement of the confidentiality 10 of the data they release to the service.
g. Obtain 13 identifying information about healthcare provider from whom the records are to be obtained.
h. Collect 14 payment information from the client.
i. Verify 15 payment information.
j. Test 16 if verification is successful.
k. If verification unsuccessful then notify 17 client of unsuccessful payment information verification.
l. If verification is successful then (please turn to FIG. 5) send request 31 to healthcare provider for electronic transfer of de-identified patient medical records.
m. After a predetermined period of time check 19 to see if records have been received.
n. If records have not been received then go back to 31.
o. If records have been received then reformat 18 data (if necessary). At first it may only be possible to analyze records transferred from a few EMR systems due to problems of data incompatibility. Some data translation can be done when formats are similar. In time, as industry data formats are standardized this problem will be minimized or eliminated.
p. Add 32 the patient data to the de-identified patient data store 34.
q. Perform 23 & 24 the chart analysis. These steps will be described in greater detail below.
r. Generate client report 33 and add 26 report to the healthcare provider data store 35.
s. Transmit 27 the report to the client.
t. Optionally, wait 28 for a predetermined period of time and then transmit request 29 for the client to complete an online satisfaction survey.

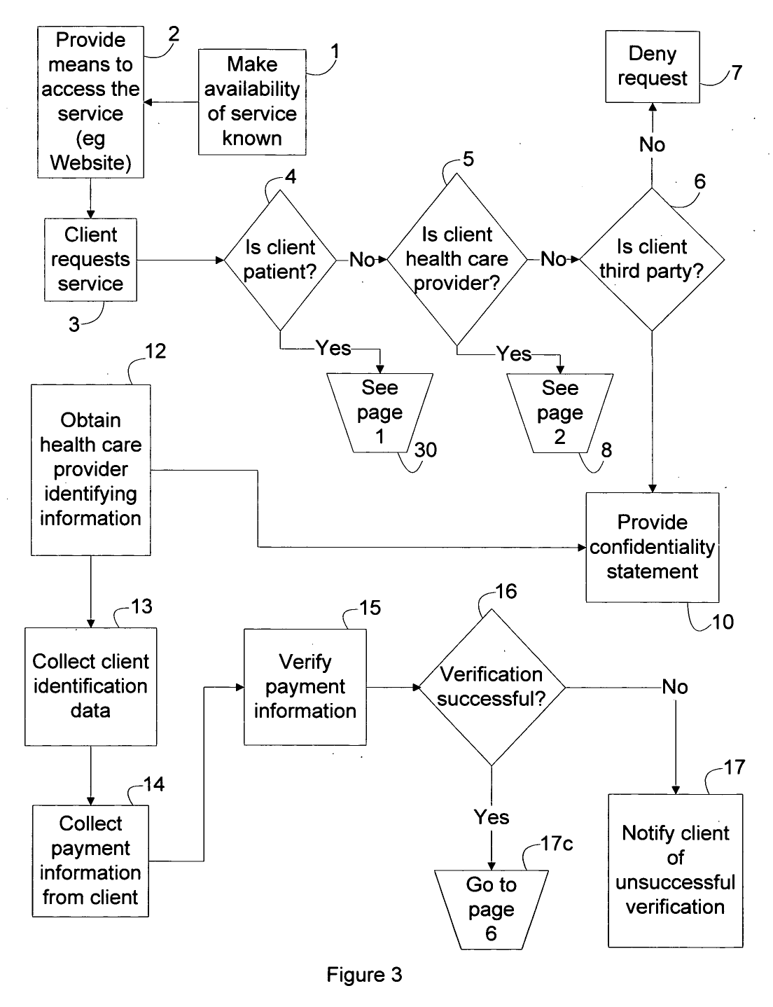

3. Case of qualified third party as client (see FIG. 3):

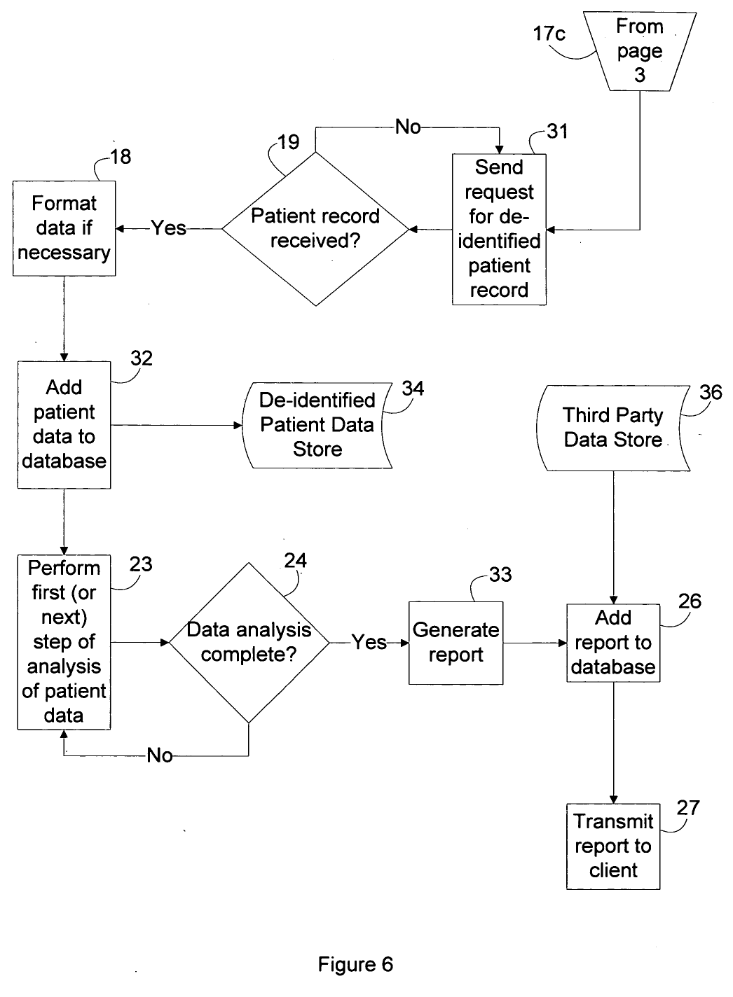

Some third parties may be qualified to obtain reports of the analysis of de-identified patient data. Examples include State licensing boards and medical specialty certification boards that have valid reason to use such information to serve the public interest.
a. The availability of the medical record review service is made known 1 such as through direct contact.
b. An Internet website is provided 2 for access to the service.
c. Client requests the computerized review of electronic medical records 3.
d. In this case the client is a qualified third party so tests 4 and 5 are false.
e. In this case the client is a qualified third party so test 6 is true.
f. Provide the client with a statement of the confidentiality 10 of the data to be analyzed by the service.
g. Obtain 12 identifying information about healthcare provider from whom the records are to be released.
h. Collect 13 client identifying information.
i. Collect 14 payment information from the client.
j. Verify 15 payment information.
k. Test 16 if verification is successful.
l. If verification is unsuccessful then notify 17 client of unsuccessful payment information verification.
m. If verification is successful then (please turn to FIG. 6) send 31 request to healthcare provider for electronic transfer of the patient medical records.
n. After a predetermined period of time check 19 to see if records have been received.
o. If records have not been received then go back to 31.
p. If records have been received then reformat 18 data (if necessary). At first it may only be possible to analyze records transferred from a few EMR systems due to problems of data incompatibility. Some data translation can be done when formats are similar. In time, as industry data formats are standardized this problem will be minimized or eliminated.
q. Add 32 the patient data to the de-identified patient data store 34.
r. Perform 23 & 24 the chart analysis. These steps will be described in greater detail below.
s. Generate report 33 and add 26 report to the third party client data store 36.
t. Transmit 27 the report to the client.

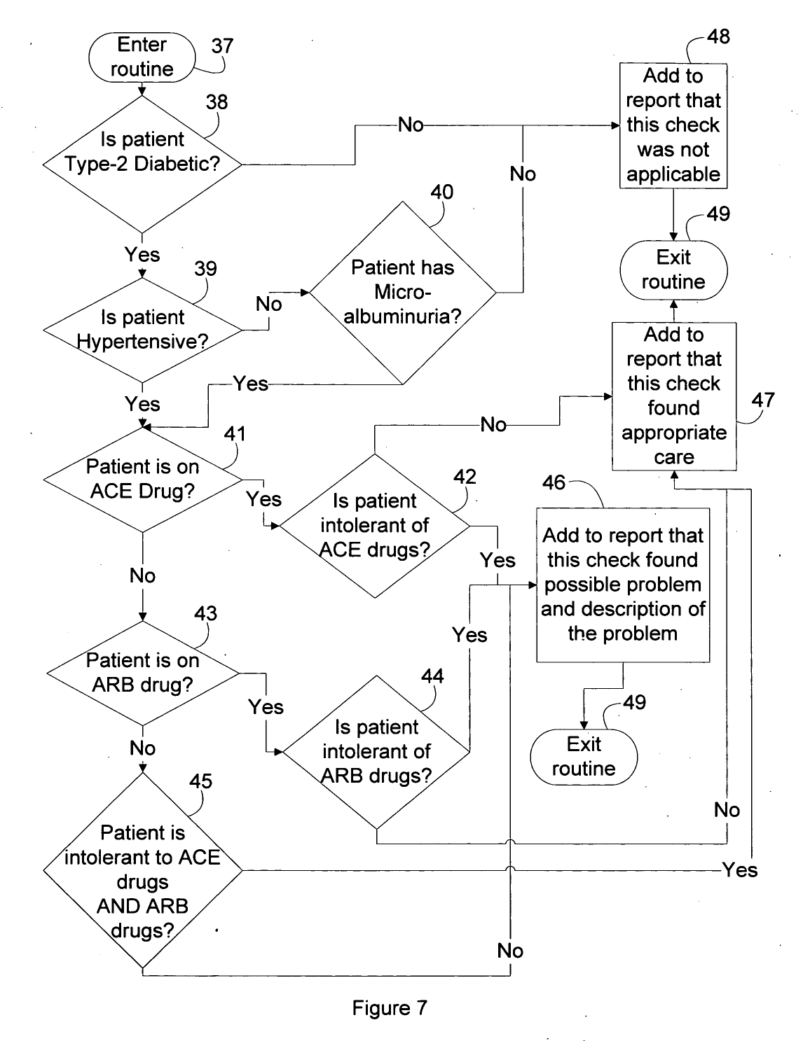

4. Analysis of patient electronic medical record (see FIG. 7 except as noted below):

At first it may only be possible to analyze records transferred from a few EMR systems due to problems of data incompatibility and the fact that some EMR systems record data in a free text format versus encoded data. Some data translation can be done when formats are similar. In time, as industry data formats are standardized this problem will be minimized or eliminated.
a. Processes 23 and 24 are the same in FIGS. 1, 2 and 3 in which the clients are patients, providers and third parties respectively. These processes operate in a loop in which each of a set of analytical algorithms are used in turn until all the algorithms have been applied to the patient record.
b. FIG. 7 represents one relatively simple yet non-trivial sample algorithm. It is chosen because it represents an important and often overlooked issue in the care of diabetic patients. The algorithm is described below:
c. Algorithm entry point 37.
d. Does 38 the patient have type-2 diabetes? This can be determined from the problem list in the EMR. Most cases in which the diagnosis has been made but not added to the problem list can be found by checking the EMR's historical record of laboratory reports and finding a glycohemoglobin result of greater than some predetermined cutoff such as 7%.
e. If the answer to 38 is NO then go to 48 which adds to the report which is being generated that this algorithm was run and found not to apply then exit this algorithm 49.
f. If the answer to 38 is YES then go to 39
g. Does 39 the patient have hypertension? This can be determined from the problem list in the EMR. Some other cases can be found by checking the EMR's historical record of vital signs and discovering blood pressures above some predetermined cutoff such as for example the average of 4 consecutive blood pressures greater than 120 systolic or 80 diastolic.
h. If the patient has hypertension then go to 41.
i. If patient is determined NOT to have hypertension then go to 40. Does 40 the patient have microalbuminuria? This can be found by checking the EMR's historical record of laboratory reports and finding an albumin:creatinine ratio greater than 30 on two occasions.
j. If the patient does NOT have microalbuminuria then go to 48 which adds to the report which is being generated that this algorithm was run and found not to apply then exit this algorithm.
k. If the patient DOES have microalbuminuria then go to 41.
l. Is 41 the patient on an ACE drug? This can be determined by checking the medication list for drugs of the class “ACE inhibitor”.
m. If the answer is YES then go to 42 which determines if this patient is intolerant of ACE drugs by checking the EMR's list of drug sensitivities.
n. If the answer is NO then add 47 to report that this algorithm found appropriate care then exit the algorithm 49. If the answer is YES then add 46 to the report that a possible problem was found and a description of the problem (patient on a drug with a known sensitivity to that drug or class) then exit the algorithm 49.
o. If the patient is not on an ACE drug then go to 43.
p. Is 43 the patient on an ARB drug? This can be determined by checking the medication list for drugs of the class “ARB”.
q. If the answer is YES then go to 44 which determines if this patient is intolerant of ARB drugs by checking the EMR's list of drug sensitivities.
r. If the answer to 44 is NO then add 47 to report that this algorithm found appropriate care then exit the algorithm 49. If the answer is YES then add 46 to the report that a possible problem was found and a description of the problem (patient on a drug with a known sensitivity to that drug or class) then exit the algorithm 49.
s. If the answer to 43 is NO then go to 45.
t. Is 45 the patient intolerant of both ACE and ARB drugs?
u. If the answer is YES then add 47 to report that this algorithm found appropriate care and exit the algorithm 49. If the answer is NO then add 46 to the report that a possible problem was found and a description of the problem then exit 49 the algorithm. A sample description of this problem is as follows: “A computerized review of your electronic medical record found that you have type-2 diabetes and either microalbuminuria or hypertension or both. This combination is usually an indication for the use of a drug called an ACE or ARB because in this situation use of these drugs helps to protect your kidneys from being damaged by your diabetes. There may be good reasons why your provider has not recommended one of these drugs or it might have been overlooked. It is suggested that you see your healthcare provider to discuss whether use of one of these drugs might be valuable for you.”
   In general the analysis of the EMRs may utilize any of the data in the electronic record including the following list which is not intended to be exhaustive:
a. Current problem list
b. Current drug list
c. Past medical and surgical history
d. Family history
e. Drug allergies and intolerances
f. Immunization history
g. Social history and other special risk factors
h. Results of all investigations including laboratory, radiology, EKG and others
i. Historical record of vital signs
   The analysis applies a large number of algorithms to check for problems of the types described below (which again is not intended to be exhaustive):
(a) Is all the proper routine screening being done and being done at the proper intervals?
(b) Is special case screening being done? For example:
   (i) Starting PSA (prostate specific antigen) tests early in a patient with a family history of prostate cancer?
   (ii) Starting mammograms early in a patient with family history breast cancer?
   (iii) Starting colonoscopies early in a patient with a family history of colon cancer?
(c) Are any inappropriate drugs being used?
   (i) Drug interactions
   (ii) Drugs that are not appropriate for the age of the patient (eg Beers' Criteria)
   (iii) Drugs that are not appropriate for the disease state(s) of the patient?
   (iv) Inappropriate doses
(d) Does the patient have medical problems which might be caused by the current treatments for example:
   (i) Patient has a diagnosis of chronic cough and is taking an ACE (angiotensin converting enzyme) inhibitor drug which can cause chronic cough.
(e) Are drugs that should be used for the patients disease state(s) not being used? For example:
   (i) ASA (acetylsalicylic acid, aspirin) for patients with a history of ischemic heart disease
   (ii) Appropriate beta blockers for patients with ischemic heart disease
   (iii) ACE or ARB (angiotensin receptor blocker) drugs for patients with congestive heart failure
(f) Is there any indication of undiagnosed diseases which can be suspected based on data in the EMR? For example:
   (i) A patient with chronic lung disease will usually have a relatively high blood hemoglobin level. Blood loss such as from a colon cancer could result in a drop in the hemoglobin such that it is then low in the laboratory's normal range. A health care provider reviewing the laboratory result could easily see that it is in the “normal” range and fail to notice the important change.
(g) The system can examine and report parameters of disease control for example:
   (i) Glycohemoglobin and microalbumin levels in diabetics. The report can show the patient results, how they have changed over time and the goals for these parameters. It also can explain the standard of care for how frequently this type of testing should be done and why. When the patient is the cause of poor compliance with the standards this education should help to improve the compliance. When the healthcare provider is the source of poor compliance this should help the patient to overcome that problem or to make the decision that he needs to find a different healthcare provider.
(h) The system can examine and report parameters of disease monitoring for example:
   (i) When a patient with hypertension has drug treatment started or changed he should be seen again after some interval such as one month to assess the response. In many cases the patient does not return for follow-up but instead obtains prescription refills by telephone. Long periods of time may go by before the patient is seen again and it is recognized that the blood pressure is still not adequately controlled. This system can determine if the patient is seeing the healthcare provider at appropriate intervals or not. It can report if there is a problem and explain why this follow-up is important.
(i) The system can examine and report parameters of drug monitoring for example:
   (i) Many drugs have recommended monitoring that does not get done. In a patient with many diseases and many drugs it is very easy to miss the fact that a certain drug has not been checked for blood level or toxicity for a long time. These oversights can be detected and reported to the patient.
(j) The system can calculate estimated cost of the patient's total drug treatment and suggest possible drug alternatives to reduce the cost. The patient can discuss these suggestions with his healthcare provider. This has the potential for cost savings for the patient and since high drug costs are an important factor in non-compliance this can improve compliance with treatment.
(k) The system can report to the patient the range of prices from various sources for the exact drugs that the patient is taking. Many patients including a lot of Medicare patients have small fixed incomes and large medication expenses. They are often unaware that they can obtain medications much less expensively through sources other than the local pharmacy. This service can provide the patient with the information they need to use the less expensive sources.
(l) Other algorithms that deal with diagnostics and therapeutics could be implemented with sequential logic. More complex diagnostic and therapeutic analysis could be implemented using artificial intelligence.
   Additional Embodiment:

a) Flat file database or other database architectures.

b) The algorithms can be coded into the software instead of being kept as a separate database of algorithms.

c) Artificial intelligence can be used in addition to or in place of sequential logic algorithms for the analysis of the patient records.

Operation—Additional Embodiment:

a) Third parties could require healthcare providers to regularly submit de-identified patient data for analysis and reporting to the third party.

b) The makers of EMR systems could incorporate into their software the automatic submission of randomly selected data or all data for analysis and reporting to the patients or third parties.

c) The system can search for and report on possible occult diseases that could easily be missed by the physician and yet have clues that are readily available in the EMR. For example a patient with high blood pressure and low potassium who is not on a diuretic drug may have high blood pressure because of an abnormally high aldosterone level.

d) The system can examine and report laboratory parameters of disease control and monitoring. For example it can list and/or graph glycohemoglobin levels in diabetics to show the patient how he is doing with diabetes control compared to goals. It can examine the frequency at which drug or disease monitoring tests are being done and report if the intervals are appropriate or not and if not then provide suggestions for proper follow-up. This can help the patient to understand proper management of their disease. This could be extremely valuable for diabetic patients who often have laboratory disease monitoring much less frequently than is optimal.

e) The system can examine and report healthcare provider visit parameters of disease control and monitoring. For example it can detect that a diabetic patient who is not adequately controlled based on glycohemoglobin results is seeing his healthcare provider only once per year instead of the four or more times per year that would be standard of care. This deficiency in care can be demonstrated to the patient with an explanation of why it is important, so as to achieve improved compliance with the standard of care. This could be effective regardless of whether the problem of deficient care lies with the patient or the healthcare provider.

### CONCLUSION, RAMIFICATION AND SCOPE

Conclusion:

This invention provides a process and system for the review of EMRs to detect inappropriate medication use, missed opportunities for beneficial medication use and missed opportunities for appropriate healthcare screening. The review is done by a computer program which applies up to date evidence based medical information. The entire medical record is available for analysis as opposed to just billing data or prescription data as in previous systems. For this reason a much more meaningful analysis can be accomplished. The client can be the patient or a third party and results of the review are returned to the client requesting the review for the purposes of assessing the quality of medical care and optimizing medical care.

Ramification:

The primary result intended with this invention is the improvement of quality of medical care for those patients who choose to use the system. Unanticipated advantages result from applying pressure on healthcare providers and the makers of EMR systems which will result in improved healthcare quality for all patients including those that do not use the service that this invention provides. It provides the opportunity for third parties such as licensing and certifying boards to assess the quality of healthcare provided by individual practitioners in day to day practice, something which is currently impossible for them to do reliably. The makers of EMR systems are beginning to provide software clinical tools intended to help the healthcare provider improve the quality and consistency of healthcare. This invention provides the opportunity to directly compare the outcomes that result from the use of different EMR systems and their associated clinical tools. This invention also provides education for the patient helping him to understand appropriate care for his specific diseases in terms of treatment, laboratory monitoring and healthcare provider visits resulting in improved patient involvement and compliance.

Scope:

The term “electronic medical record” or EMR is used in this patent application but it is intended that this include electronic health record systems (EHR's) as well. This invention is intended to cover all implementations which use a computer to review an EMR or EHR for the purpose of reporting to the patient or a third party. It is to be understood that the implementations described in this application are not the only possible implementations and that other options will be apparent to those skilled in the art from consideration of the specification and practice of the invention disclosed herein. It is intended that the specification and examples be considered as exemplary only. The scope of the invention should be determined by the appended claims and their legal equivalents and not solely by the examples given.

1. A method for assessing and improving the quality of medical care comprising:
providing a means for a plurality of clients to request an assessment of a plurality of electronic medical records, providing a means for the computerized analysis of said electronic medical records, providing a means to report results of said computerized analysis to said clients.

2. A method for assessing and improving the quality of medical care of claim 1 wherein said clients are selected from the group consisting of patients, companies that make electronic medical record systems, vendors of electronic medical record systems, distributors of electronic medical record systems, medical specialty boards, insurance companies, licensing authorities, hospitals, public health quality assurance organization, private health quality assurance organization, and any representative of any of the preceding clients.

3. A method for assessing and improving the quality of medical care of claim 1 wherein said assessment of a plurality of electronic medical records may be requested individually or in groups.

4. A method for assessing and improving the quality of medical care of claim 1 further including providing a means to obtain a plurality of said electronic medical records.

5. A method for assessing and improving the quality of medical care of claim 4 wherein said electronic patient records are obtained individually.

6. A method for assessing and improving the quality of medical care of claim 4 wherein said electronic patient records are obtained in groups.

7. A method for assessing and improving the quality of medical care of claim 1 wherein patient identifying information has not been removed from said electronic medical records.

8. A method for assessing and improving the quality of medical care of claim 1 wherein said patient identifying information has been removed from said electronic medical records.

9. A method for assessing and improving the quality of medical care of claim 1 wherein said analysis is done of individual electronic medical records.

10. A method for assessing and improving the quality of medical care of claim 1 wherein said analysis is done of groups of electronic medical records.

11. A method for assessing and improving the quality of medical care of claim 1 wherein said analysis is done through the application of logic sequence methods.

12. A method for assessing and improving the quality of medical care of claim 1 wherein said analysis is done through the application of artificial intelligence.

13. A method for assessing and improving the quality of medical care of claim 1 wherein said report relates to the results of analysis of individual said electronic medical records.

14. A method for assessing and improving the quality of medical care of claim 1 wherein said report relates to the results of analysis of groups of said electronic medical records.
